(19) United States
(12) Patent Application Publication
(10) Pub. No.: US 2016/0160554 A1
(43) Pub. Date: Jun. 9, 2016

(54) FACEPLATE BODY FOR A FUNCTIONALLY ESSENTIAL STRUCTURAL COMPONENT WITH A FACEPLATE, AT WHICH A SUPPORT ELEMENT IS DISPOSED

(71) Applicant: DORMA Deutschland GmbH, Ennepetal (DE)

(72) Inventors: Kenan AYKAS, Ennepetal (DE); Jorg SUNDERBRINK, Ennepetal (DE); Thomas UBELGUNNE, Ennepetal (DE); Markus HAGELBOLLING, Ennepetal (DE)

(21) Appl. No.: 14/958,654

(22) Filed: Dec. 3, 2015

(30) Foreign Application Priority Data
Dec. 4, 2014 (EP) 14196294.4

(51) Int. Cl. E06B 3/30; E05D 11/00; E05D 5/02

(52) U.S. Cl. CPC E06B 3/30; E05D 5/0246; E05D 11/0054

(57) ABSTRACT

A faceplate body for a functionally essential structural component, in particular for a fitting with a faceplate having at least the appearance of a decorative element, and with a support element. The faceplate body is configured with at least one attaching means for connecting to the functionally essential structural component.

### TECHNICAL FIELD

The disclosure relates to a faceplate body for a functionally essential structural component, in particular for a fitting.

### BACKGROUND

Faceplates are known from the state-of-the-art, which are in particular disposed at door fittings and/or corner fittings of doors or walls. The doors or walls may be made in particular from glass. Said faceplates are made from metal, sheet metal as well as often three-dimensionally formed, wherein the shaping is to be adapted individually with regard to the structural component. Moreover, it has substantially proven to be disadvantageous that the manufacturing methods of such faceplates are difficult, expensive and not at all flexible with regard to the overall manufacturing process. In addition to the relatively high weight of the faceplate, it is disadvantageous that complicated attaching connections are often necessary to dispose the faceplate reliably at the functionally essential structural component, in particular at the fitting.

The disclosure overcomes the above-described disadvantages. The disclosure provides an inexpensive and simple faceplate for a functionally essential structural component, wherein in addition a simple mounting can be achieved.

### SUMMARY

Features and details of the disclosure will become apparent from the dependent claims, the description and the drawings. In this case, features and details, described in conjunction with the faceplate body are obviously also valid in conjunction with the inventive device and/or the faceplate arrangement and/or the inventive method, and respectively vice versa, such that mutual reference is made, respectively can be made with respect to the disclosure of individual aspects of the disclosure.

According to the disclosure, a faceplate body is intended for a functionally essential structural component, in particular for a fitting with a faceplate having at least the appearance of a decorative element, and with a support element, wherein the faceplate body is configured with at least one attaching means for the attachment to the functionally essential structural component. One advantage of the disclosure is that a simple adaptation of the faceplate body to different geometrics of functionally essential structural components, in particular fittings is conceivable. It is conceivable to utilize a faceplate, which is configured in the same way for different functionally essential structural components, and different support elements can be disposed individually at the faceplate in relation to the geometrics of the functionally essential structural component. The faceplate can be attached to the support element, respectively is attached thereto, wherein the support element can be disposed at the functionally essential structural component. Preferably, the faceplate and the support element are manufactured separately of each other. The proper attachment of the faceplate body to the functionally essential structural component is realized via the attaching means, which may be disposed at the faceplate and/or the support element, wherein the mentioned attaching means can be brought into an operative connection with the functionally essential structural component. Advantageously, a wider flexibility in the design of the faceplate body is thereby achieved, wherein simultaneously just the shape, the appearance, in particular the color, geometrics etc. of the support element need to be adapted with regard to the functionally essential structural component. In the event the faceplate body was damaged, advantageously, just one part, the support element or the faceplate need to be exchanged. It is likewise conceivable that an attachment of the faceplate to support element can be realized via the functionally essential structural component. The faceplate is in particular applicable to a fitting for glass doors or glass walls.

It may be advantageous, if the support element is made from plastic material. Thereby, an inexpensive manufacturing of the faceplate body can achieved, while reducing the overall weight. Advantageously, the support element is an injection molding part or a 3-D-print part.

Advantageously, the faceplate may be made from a material, which is embodied in metal or glass or lumber or leather or plastic material. Thus, a faceplate body according to the disclosure can be provided, which satisfies the most various design wishes. A metal faceplate is distinguished by its high stability, wherein in addition the metal represents an increased protection function for the functionally essential structural component. In the event the faceplate body is to be employed at glass walls/glass doors, a faceplate made from glass could be indicated, whereby an overall uniform appearance can be achieved. The faceplate made from plastic material may include different design embodiments, in particular realized in one or diverse colors. In one possible embodiment of a faceplate made from plastic material, it may be provided according to the disclosure that the surface of the faceplate is coated, wherein the color and the material of the coating can be adapted according to the field of application and/or to customer specifications.

It is likewise advantageous, if the faceplate is positively and/or non-positively connected and/or connected by substance to the support element, in particular at least one connecting element, which is invisible from the outside, ensures that a reliable attachment between the faceplate and the support element is provided. Depending on the material pairing, faceplate and support element, different attachments in particular positive and/or non-positive and/or substance connections are applicable. Based on the invisible connecting element, an advantageous manipulation protection can be achieved. In addition, the connecting element invisible from the outside allows for achieving an appealing overall design of the faceplate body.

It is likewise advantageous, if the faceplate and/or the support element include at least one connecting element. In the event of a positive and/or non-positive connection, the connection between the faceplate and the support element may be a latching connection. A simple mounting and dismounting are conceivable with the positive and/or non-positive connection. In particular in the event of a positive and/or non-positive connection, the connecting element may be configured from uniform material and/or integrally in the faceplate and/or in the support element, wherein preferably the connecting element of the support element is a monolithic part of the support element. The connecting elements may be provided spaced apart from a visible side of the faceplate and/or of the support element. Depending on the technical requirements and/or the material to be employed, in particular with regard to the faceplate and support element, the faceplate and/or the support element may be embodied with at least one connecting element for achieving a reliable attachment of both elements.

It may be advantageous, if the faceplate includes a flat plate element, which has a front side and a back side, wherein the back side is facing the support element, in particular the backside is attached to the support element. The connecting elements for example, which are provided at the faceplate and/or at the plate element and/or at the support element, are able to effectively achieve an attachment of the faceplate/plate element to the support element.

It is likewise advantageous, that the support element is configured with a cavity, which is able to accommodate at least partially the functionally essential structural component, wherein in particular the cavity is delimited by a walling, in particular a surrounding walling, and by a bottom of the support element. One advantage of the cavity relates to being able to create a compact overall arrangement of the faceplate body with the functionally essential structural component. Advantageously, in its assembled condition, the functionally essential structural component is at least partially located in the cavity, in particular it is accommodated in the cavity. The walling conceals in particular at least partially the functionally essential structural component and thereby serves as a visual protection with regard to the functionally essential structural component. Thus, it is conceivable that the support element serves as a type of housing for the functionally essential structural component and may include in addition a certain protecting function.

Preferably, the walling is at least partially visible from outside. Particularly preferred, the walling is completely visible from outside. It may be e.g. that the walling and the sides of the faceplate form the sides of the faceplate body.

In particular, the support element may be configured as a frame. The course of the support element may be interrupted at least on one side.

Furthermore, it may be advantageous, if the faceplate and the support element are attached to each other by means of an adhesive medium. In this case, the connecting element between faceplate and support element may be an adhesive medium, which may be provided in addition or alternatively to a positive and/or non-positive connection. It has proven to be advantageous that, in a faceplate made from glass, an adhesive medium is advantageous as the connecting element, the advantages being in particular seen in the mounting speed and the manufacturing costs.

It may be intended for the inventive faceplate that the support element includes a walling, in particular a surrounding walling and a bottom, wherein the back side of the faceplate rests on the bottom and/or is attached to the bottom, wherein in particular the walling and the bottom form a common structural component as the support element. In the mounted condition of the faceplate body, the walling encloses at least partially the functionally essential structural component, wherein the walling may act as a type of housing for protecting the functionally essential structural component against environmental influences such as dust, radiation, sun, humidity, etc. Advantageously, the course of the walling is essentially adapted to the geometrical exterior contour of the functionally essential structural component. The bottom may serve on the one hand as an abutment for the functionally essential structural component. It is likewise conceivable that the other side of the bottom, facing away from the functionally essential structural component, abuts against the faceplate, in particular against the flat plate element. Thus, the bottom may include a supporting function for the faceplate and/or for the functionally essential structural component.

The disclosure may comprise in addition that the bottom is configured with a depression, into which the adhesive medium can be introduced for achieving an attachment between the bottom and the faceplate, wherein in particular the bottom includes an interior side and an exterior side, wherein the exterior side is configured with the depression. The depression, which in particular can amount to less than 1 mm, serves as the reception area for the adhesive medium, whereby the faceplate can be attached flush to the support element. Advantageously, no gap is created.

Furthermore, it is advantageous, if the plate element is configured and/or manufactured bending-free from metal, in particular if the plate element is a stamped part made from metal and the faceplate includes a stamped part from metal. Thereby, a simple and inexpensive manufacturing of the faceplate body, in particular of the faceplate can be achieved. Preferably, the plate element represents a flat element, which can be produced in different manufacturing methods, for example by stamping or laser machining. In addition, an expensive surface treatment is not necessary, in particular not one that would be disadvantageously required with a deep-drawing process. Thus, for example after manufacturing from sheet metal, the front side of the plate element may remain untreated. Advantageously, the plate element may be configured from sheet metal by means of two-dimensional shaping, such as water jet cutting or laser machining or milling.

Furthermore, an inventive faceplate body may provide that both the support element includes at least one connecting element and the faceplate includes at least one connecting element, wherein in particular the connecting element of the support element is in operative connection with the connecting element of the faceplate. Thereby, a reliable attaching action can be achieved between the support element and the faceplate.

Furthermore, according to the disclosure it may be provided that the connecting element is attached, in particular welded on the back side of the faceplate, wherein in particular the connecting element of the faceplate includes a latching element, which is in operative connection with a counter-latching element, which the support element includes.

Advantageously, it has proven that with welding, the positions of the connecting elements can be individually selected at the faceplate. In addition, the welding method is dimensioned such that no surface damages happen during the welding process on the front side of the plate element. The latching elements of the connecting element may be configured for example as a depression or as a thread. The counter-latching elements may be configured for example as an opening, into which the thread with its depressions can extend and will be reliably retained. Further clips or latching connections are likewise conceivable.

Advantageously, it is provided that the ratio V of material thickness M of the faceplate and depth T of the faceplate body amounts approximately to 5%≦V≦35%, in particular approximately to 10%≦V≦30%. On the one hand, an advantageous design effect can be achieved thereby, which makes the plate element “float” at the faceplate body. Furthermore, the depth of the faceplate body, in particular of the support element causes that the functionally essential structural component is at least partially and reliably covered and not visible from outside. Thus, a considerable amount of material can be saved for the faceplate, in particular for the plate element. A standardized faceplate body may surround functionally essential structural components having different depths. Advantageously, the ratio V of material thickness M of the faceplate, which is made from metal, and depth T of the support element may amount approximately to 10%≦V≦25%, in particular approximately to 15%≦V≦20%, or the ratio V of material thickness M of the faceplate, which is made from Glass, and depth T of the support element amounts approximately to 15%≦V≦35%, in particular approximately to 20%≦V≦30%. The material thickness of the faceplate allows for stabilizing the support element.

An inventive faceplate body may be configured such that the support element includes apertures, in particular that the bottom includes apertures and/or that the apertures have the shape of a segment of a circle. Advantageously, the apertures may serve for offering the required free space for the functionally essential structural component, in particular for potential attaching means, which are disposed at the functionally essential structural component. The apertures serve for providing a compact overall assembly unit.

In addition, it may be provided in an advantageous faceplate body that the course of the support element is adapted to the exterior contour of the faceplate, wherein the course of the support element is interrupted on at least one side. The at least one interruption at the carrying body may offer for example an opening for functional elements at the functionally essential structural component, whereby the functionality of the overall arrangement, in particular of the faceplate body with the functionally essential structural component is ensured, respectively increased.

Advantageously, the support element is configured as a frame, wherein the element is essentially adapted to the geometrics of the functionally essential structural component. Such a configuration of the support element offers an effective protection and an effective covering with regard to the functionally essential structural component, wherein a positive design effect of the faceplate body is produced.

Likewise a subject matter of the present disclosure is a device having at least one faceplate body of the type mentioned-above, wherein the faceplate body is disposed at a functionally essential structural component, in particular at a fitting element of a fitting, wherein the functionally essential structural component is at least partially concealed by the faceplate body. The functionally essential structural component may include a fitting, in particular a corner fitting, wherein the fitting may be disposed at a door and/or a stationary wall. The fitting may provide for example a center of rotation for a door, wherein the faceplate body covers the fitting. Advantageously, the functionally essential structural component may include a depression into which the support element extends with the bottom thereof. Hereby, a close abutment of the faceplate body against the functionally essential structural component can be achieved. A compact overall arrangement can be achieved thereby.

It is likewise advantageous, if the fitting includes two fitting elements, which are interconnected, wherein each fitting element includes a faceplate body on its exterior side. In this case, it is conceivable that at least one attaching element connects both fitting elements, wherein the attaching element is at least partially disposed in particular in the aperture of the support element.

In addition, an independent subject matter of the present disclosure comprises a faceplate arrangement with at least two faceplate bodies disposed at each other, in particular of the type just mentioned, wherein a first faceplate body is disposed at a first functionally essential structural component and covers the second structural component at least partially, a second faceplate body is disposed at a second functionally essential structural component and covers the second structural component at least partially, the first and the second faceplate bodies include several corner areas, wherein the corner areas of the first faceplate body, which are facing the structural component, are configured as angular corner areas, and the corner areas of the first faceplate body, which are facing away from the second structural component, are configured as rounded corner areas. On the one hand, the geometrical configuration of the corner areas offers the advantage of saving material, which refers to the angular corner areas. The rounded corner areas keep the risk of injury low, in particular when mounting and/or when utilizing the faceplate arrangement. In addition, the overall impression can be improved from the design technical point of view by means of the different geometrical configuration of the corner areas. The advantages mentioned with regard to configuring the corners include an independent inventive concept.

In particular it has proven advantageous that the first faceplate body is disposed at a stationary part and the second faceplate body is disposed at a mobile part, wherein in particular the stationary part and the mobile part are made from glass material.

Moreover, the subject matter of the present disclosure is a method for manufacturing a faceplate body, in particular of the type mentioned-above, wherein the faceplate body includes a faceplate as well as a separate manufactured support element, wherein the method comprises at least the step of:
b) attaching the support element to the faceplate.

According to the disclosure, it is hereby conceivable that attaching the support element to the faceplate is realized via a latching connection and/or via bonding. The mentioned attachment has proven to be mounting-friendly, wherein furthermore, it is conceivable that the support element and/or the faceplate include at least one connecting element for achieving an attachment of the support element to the faceplate, in particular that the connecting element is disposed at the support element and/or at the faceplate prior to attaching the support element to the faceplate.

It is likewise advantageous, if in a step a), which is prior to step b), at least one connecting element is disposed at the faceplate, in particular at a flat plate element of the faceplate by means of a welding process. The inventive method may comprise for example that in step b) the faceplate with the connecting element is attached to the support element, in particular the plate element and that the connecting element disposed at the plate element form a faceplate.

Furthermore, it is conceivable that according to step a) the connecting element and/or the plate element in a step c) are melted to each other and that at least one melt is created at the plate element, wherein in step d) the connecting element is guided into the melt of the plate element.

Furthermore, the inventive method comprises that in step c) there is a distance between the connecting element and the plate element.

The movement of the connecting element, which is to be welded to the plate element, may be realized via a lifting device.

According to one possible inventive idea of the inventive method, the connecting element may include latching elements, wherein the connecting element includes a free end, which is embodied to be tapered, wherein the free end is melted according to step a). The geometrical configuration of the connecting element with the tapering presents among others the advantage of being able to achieve a reliable attaching action thereby.

Moreover, it is conceivable that, above the free end, the connecting element includes a collar element, which in particular acts as a support and/or positioning assistance during step d). The collar element improves the positioning of the connecting element at the plate element.

Moreover, it may be advantageous that the connecting element and the plate element are made from the same material, in particular that the connecting element and the plate element contain aluminum or are made from stainless steel. The precipitation of a same material for both, the connecting element and for the plate element has advantages with regard to the welding process, in particular good attaching effects are achieved for the connecting element to the plate element.

For achieving a good attaching effect between the plate element and the connecting element, it may be advantageous that the ratio W between the thickness of the plate element to the diameter of the connecting element amounts to 0.5≦W≦1. It has proven that hereby no welding traces will occur on the front side of the plate element.

According to the disclosure, it is conceivable that the method employs a welding technique, which is in particular an arc welding technique. Moreover, it is conceivable that the welding process is realized with protective gas for achieving a perfect connection between the connecting element and the plate element.

Advantageously, the plate element is manufactured bending-free. The plate element is for example stamped, machined by laser or milled out or cut, in particular in a water cutting technique. It is conceivable that depending on the technical requirements, the side surfaces of the plate element will be further machined, in particular smoothened, which depends among others on the application field of the faceplate body. Manufacturing the plate element is realized prior to step a) of the method and may be a part of the inventive method. In particular step a) is performed prior to step b).

According to the disclosure, it may be provided that after step b), the faceplate abuts at the support element without distance, wherein in particular a tension is effective between the faceplate and the support element, wherein in particular the tension is caused by at least one connecting element. A compact overall arrangement is created hereby, wherein a reliable support between the faceplate and the support element is ensured.

### BRIEF DESCRIPTION OF THE DRAWINGS

Further advantages, features and details of the disclosure will result from the following description, in which exemplary embodiments of the disclosure are described in detail, reference being made to the drawings. In this context, the features mentioned in the claims and in the description, individually or randomly combined, may be essential to the disclosure.

In the drawings:

FIG. 1 shows a diagrammatically illustrated faceplate arrangement with several faceplate bodies disposed next to each other,

FIG. 2 shows a faceplate arrangement with a functionally essential structural component and faceplate bodies disposed thereat,

FIG. 3 shows a diagrammatical view of a faceplate body, in which a functionally essential structural component is disposed,

FIG. 4 shows a faceplate body with a faceplate and a support element,

FIG. 5 shows a faceplate body according to FIG. 4 in a further view,

FIG. 6 shows another exemplary embodiment of a support element, which can be inserted into a faceplate body of FIGS. 1 to 5,

FIG. 7 shows the support element according to FIG. 6 in a further illustration,

FIG. 8 shows a further exemplary embodiment with a functionally essential structural component, to which a support element is attachable,

FIG. 9 shows a further exemplary embodiment of a faceplate arrangement with two faceplate bodies and a functionally essential structural component, which is surrounded by the faceplate body,

FIG. 10 shows a further exemplary embodiment of a support element with a protecting element,

FIG. 11 shows a further exemplary embodiment of a support element,

FIGS. 12a, 12b, and 12c show method steps for the attachment by substance of a connecting element to a faceplate, in particular to a plate element,

FIG. 13 shows a further illustration of a faceplate arrangement with two faceplate bodies, which surround a functionally essential structural component, and

FIGS. 14a, 14b, and 14c show a diagrammatical method illustration for manufacturing a faceplate body.

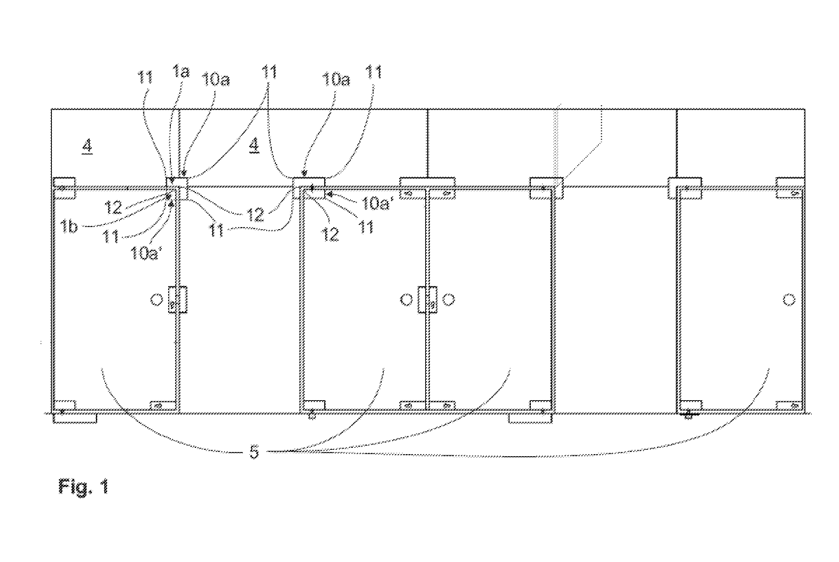

Elements and feature having the same function and mode of action are indicated in the FIGS. 1 to 13 respectively with the same reference numeral.

### DETAILED DESCRIPTION OF THE DRAWINGS

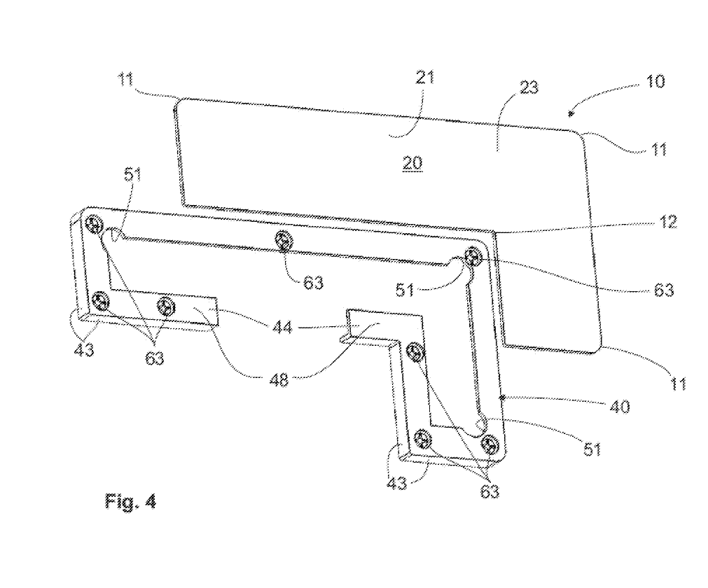

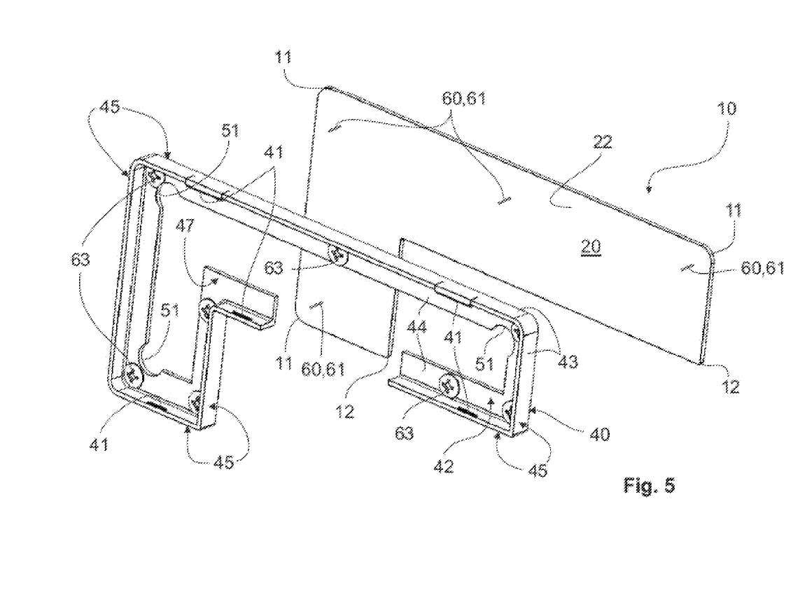

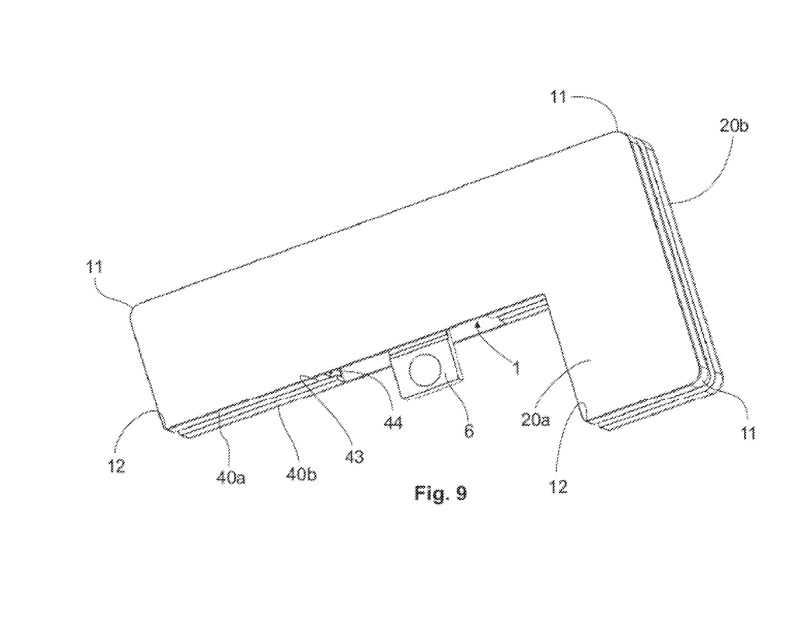

FIG. 1 shows a possible faceplate arrangement with various faceplate bodies 10a, 10a′, which cover a functionally essential structural component 1a, 1 b. The faceplate bodies 10a, 10′ are disposed next to each other, wherein the faceplate bodies 10a, 10a′ are respectively adapted to the neighboring contour. In this case, a first faceplate body 10a is disposed at a first functionally essential structural component, which is explicitly not illustrated. Said first structural component is at least partially covered by the first faceplate body, which will be explained in the following. Likewise, the second faceplate body 10a′ is disposed at another second functionally essential structural component 1b, which likewise explicitly can not be seen in FIG. 1. The second structural component 1b is partially covered by the second faceplate body 10a′. The first 10a and the second 10a′ faceplate bodies include several corner areas 11, 12, wherein the corner areas 12 of the first faceplate body 10a, which are facing the second structural component 1b, are configured as angular corner areas 12. The corner areas 11 of the first faceplate body 10a, which are facing away from the second structural component 1b, are configured as rounded corner areas 11, as also illustrated in FIG. 4, FIG. 5, and FIG. 9. The first faceplate body 10a′ is disposed at a mobile door element 5. The second faceplate body 10a′ is attached to stationary wall elements 4. The functionally essential structural components 1a, 1b, which are respectively covered by faceplate bodies 10a, 10a′, may have different technical functions. It is for example conceivable that an axis of rotation or a bolt, which serves for interlocking, etc., is disposed in one of the functionally essential structural components 1a, 1b. According to FIG. 1, the faceplate body 10a′ is configured to be angular, in particular L-shaped.

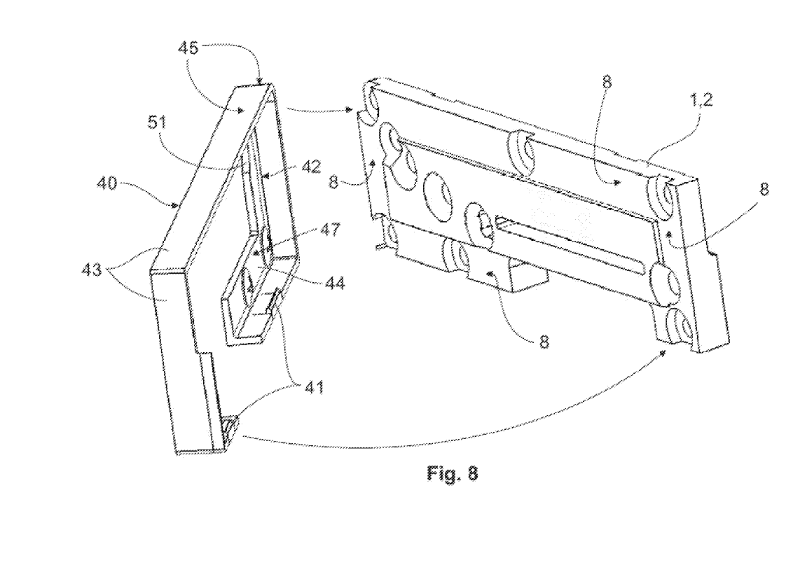

According to all exemplary embodiments, the faceplate body 10 is designed for a functionally essential structural component 1, in particular for a fitting 1 or a corner fitting, wherein the faceplate body 10 includes at least one faceplate 20 as well as a support element 40, which refers to all exemplary embodiments. According to FIG. 4, the faceplate 20 has a plate element 23 with a front side 21 and a back side 22. The plate element 23 is attachable to a support element 40. The rear view according to FIG. 5 illustrates that the support element 40 includes a cavity 42, in which attaching means 41 are disposed, which serve for attaching the support element 40 to a functionally essential structural component 1, which is shown for example in FIG. 3, FIG. 8 or FIG. 13.

The support element 40 includes a walling 43, which is configured to be surrounding and frame-like. Moreover, the support element 40 is configured with a bottom 44, which serves as a locating surface for the faceplate 20, in particular for the plate element 23 and for the functionally essential structural component 1.

The support element has several walling sides 45, wherein in the exemplary embodiments, the attaching means 41 only include two opposing walling sides 45. The bottom 44 includes an interior side 47, which is facing the functionally essential structural component 1. Furthermore, the bottom 44 includes an exterior side 48, which is associated to, respectively facing the faceplate 20 in particular the plate element 23. The plate element 23, in particular the faceplate 20 will be and/or is positively and/or non-positively connected to the support element 40, this is valid for all exemplary embodiments, wherein one exception is shown in FIG. 11, in which the exterior side 48 of the support element 40 has a depression 49, into which a connecting element 60, in particular an adhesive medium 50 can be introduced, such that when contacting the faceplate 20, in particular of the plate element 23 with the exterior side 48 of the support element 40, a reliable connection by substance can be realized. It is likewise conceivable that according to FIG. 11 in addition a non-positive and/or positive connection is realized between the support element 40 and the faceplate 20, in particular the plate element 23.

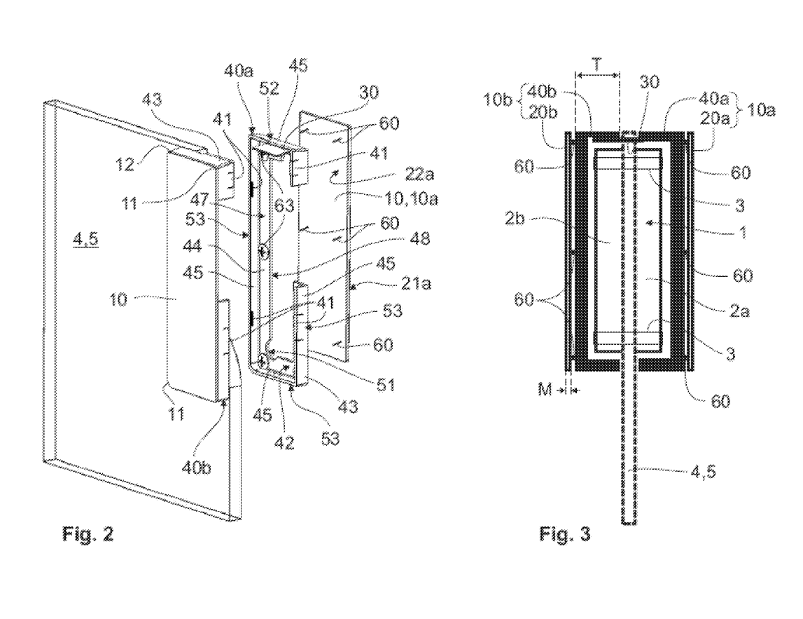

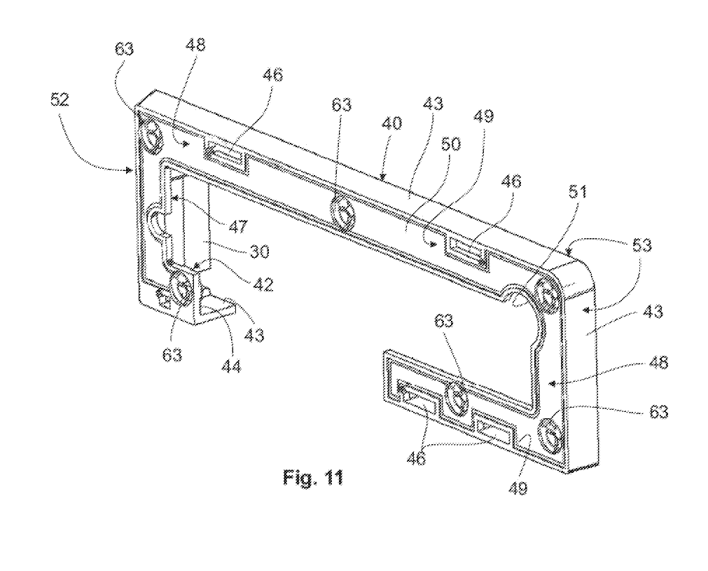

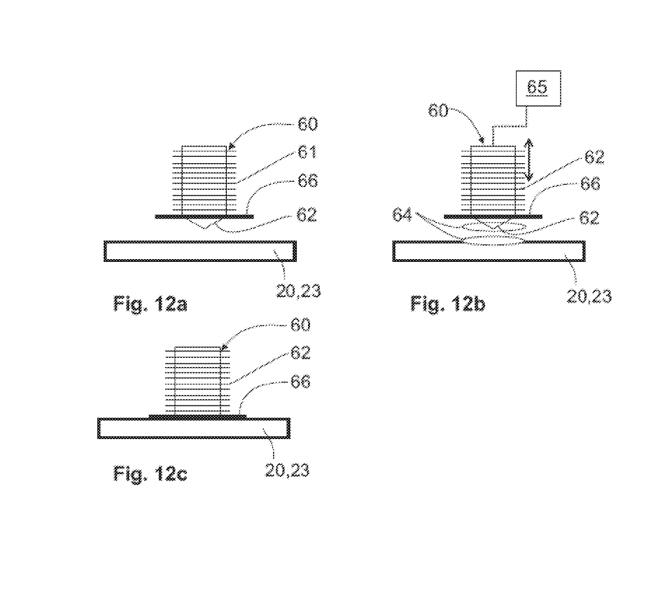

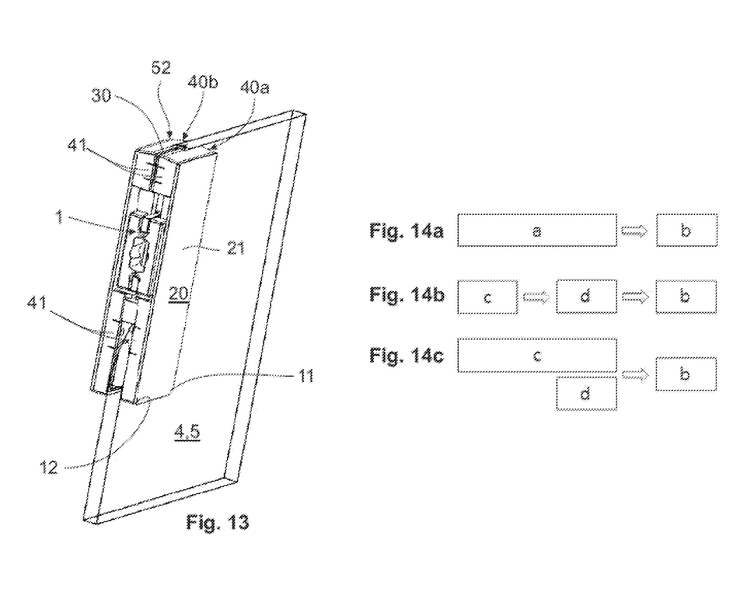

In FIG. 2, FIG. 3, FIG. 5, the connecting elements 60 are shown, which are disposed at the faceplate 20, in particular at the plate element 23 for realizing a non-positive and/or positive connection with the support element 40. The connecting elements 60 may be affixed for example by means of a welding method to the faceplate 20, in particular to the plate element 23, which is shown diagrammatically in FIGS. 12a-12c and FIGS. 14a-14c and will be explained in the following.

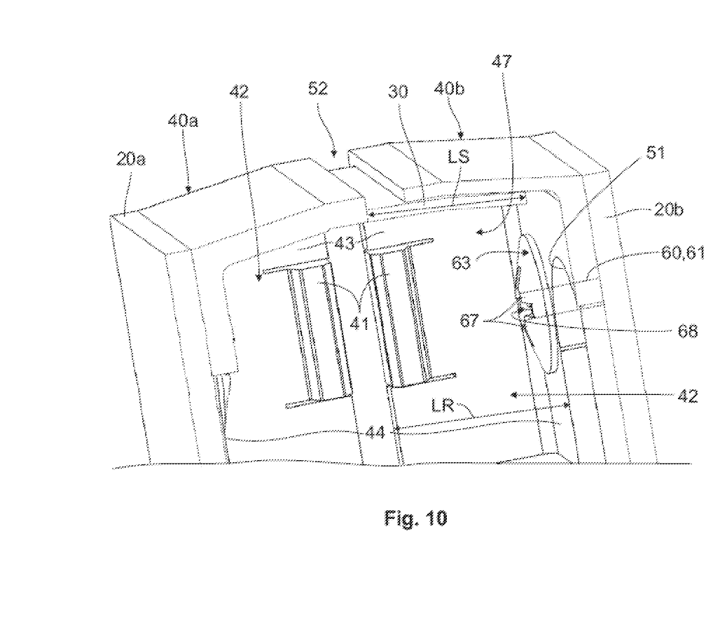

The faceplate body 10 has counter-latching elements 63 at the support element 40, which are configured as elastic wing elements. By way of example FIG. 10, shows for all exemplary embodiments that the counter-latching elements 63 moreover comprises an opening 68, into which the latching element 61 engages Advantageously, the latching element 61 includes a thread, which is embodied from a plurality of depressions, whereby at least one form closure is realized with the wing elements 67 of the counter-latching element 63. Thus, a reliable attaching effect is achieved between the plate element 23, respectively the faceplate 20 and the support element 40.

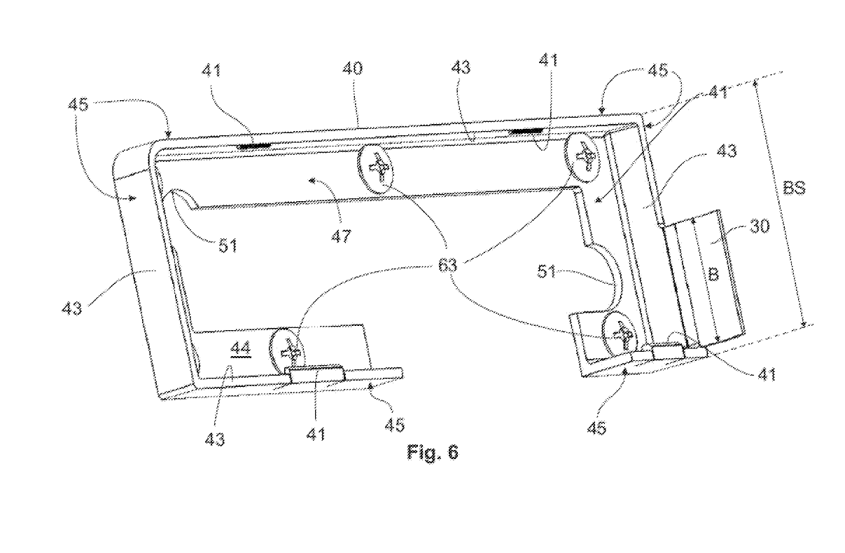

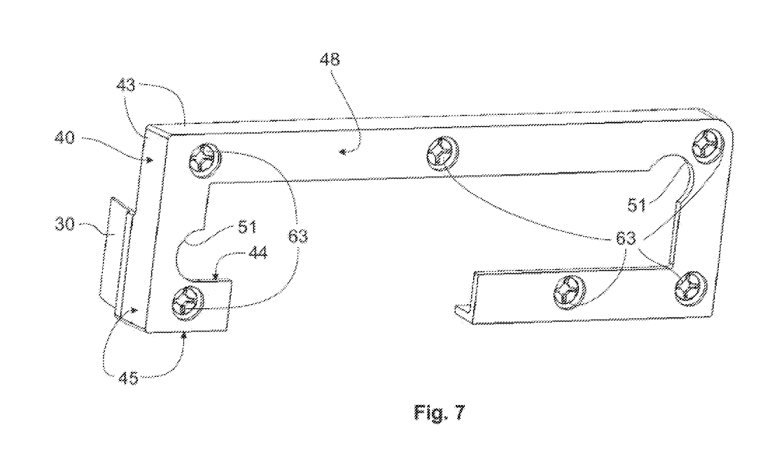

As revealed in all illustrations of the Figures, the support element 40 has one or more apertures 51, which serve for creating a free space for the functional elements of the functionally essential structural component 1. The exemplary embodiment according to FIG. 2, FIG. 7, FIG. 8, FIG. 6 corresponds essentially to the faceplate body 10 according to the above-described Figures, wherein the faceplate body 10 presents a rectangular-shaped embodiment instead of an L-shape. In all embodiments, the support element 40 is configured frame-like, wherein at least one location, respectively one area is interrupted. One reason for this is that the functional elements of the functionally essential structural component 1 are hereby allowed to reach through this area, and by way of example this is illustrated in FIG. 13 or FIG. 9. In FIG. 13, one element 1 of the functionally essential structural component 1 is shown, which protrudes through the break-through of the support element 40. FIG. 9 shows an abutting element 6, which extends like a protrusion from the faceplate arrangement. Said abutment 6 may be a door stop, in particular for the door 5 according to FIG. 1.

FIG. 8 shows a device with a faceplate body, in which just the support element 40 is shown, wherein the support element 40 can be affixed to a functionally essential structural component 1. The functionally essential structural component 1 includes a depression 8, into which the support element 40 extends with the bottom 44 thereof. This means, the geometrics of the depression 8 are correspondingly adapted to the geometrics of the bottom such as to create a compact overall unit in the assembled condition.

In FIG. 2, FIG. 3, FIG. 6, FIG. 7, FIG. 10, FIG. 11, and FIG. 13 the faceplate body 10 is configured with a protecting element 30, which laterally covers and protects the functionally essential structural component 1. The first faceplate body 10a includes a first faceplate 20a, at which a first frame element 40a is disposed. Moreover, a second faceplate body 10b comprises a second faceplate 20b, at which a second frame element 40b is disposed. The first frame element 40a includes the protecting element 30, which like a protrusion extends in the direction of the second faceplate body 10b, in particular of the second frame element 40b. In this case, the protecting element 30 is located below the second frame element 40b. Thus, an asymmetrical structural unit is created with regard to both faceplate bodies 10a, 10b. The support elements 40a, 40b are disposed spaced apart from each other at the functionally essential structural component 1. Moreover, the protecting element 30 connects the first support element 40a to the second support element 40b. In particular in FIG. 2, it is revealed that, at least on one side of the support element 40, the surrounding walling 43 presents a slanted course to the bottom 44. The slanted course can be seen there at the support element 40, where the reference numeral 43 of the support element 40b points to. The support element 40a, 40b has several sides, which are formed by the walling 43, wherein one side 52 is configured as a protecting side 52, which includes the protecting element 30. Said side 52 is likewise configured slanted towards the bottom.

FIGS. 12a-12c and FIGS. 14a-14c show by way of example the manufacturing of a faceplate 20, in particular for disposing connecting elements 60 at the plate element 23 at the faceplate 20. Initially, the plate element 23 is manufactured, wherein the plate element 23 is configured bending-free from metal according to the illustrated exemplary embodiment. In a step A, the connecting element 60 is disposed at the faceplate 20 in a welding process. According to step a), the connecting element and the plate element 23 are melted in a step c), wherein a melt 64 forms. Subsequently, the connecting element 60 is lead into the melt 64 of the plate element 23, which is realized in a step d). In step c) shown in FIG. 12b, there is a distance between the connecting element 60 and the plate element 23. According to the disclosure, a lifting device 65 is provided for realizing that the connecting element 60 is moved closer to the plate element 23. The connecting element 60 includes a free tapering end 62 as well as a thread 61, which is made from a plurality of depressions, whereby the thread 61 is thus formed from a plurality of latching elements 61, which cooperate with counter-latching elements 63, when attaching to the frame element 40 and thus form a reliable latching connection. Above the free end 62, the connecting element 60 includes a collar element 66, which acts as a positioning help during step d) (FIG. 12). According to FIG. 14, according to step a) the connecting element 60 is disposed at the flat plate element 23 in a welding process. Subsequently, according to step b), an attachment of the support element 40 to the faceplate 20 is realized. FIG. 14b shows that during the step a) step c) is realized, in which both the connecting element 60 and the plate element 23 are melted, and a melt 64 is respectively created at the plate element 23 and the connecting element 60. Subsequently, the connecting element 60 is lead into the melt 64 of the plate element 23 in a step d). According to FIG. 12c, it is shown that step d) can be already performed during step c).

FIG. 11 shows that the support element 40 may include openings 46, which are associated to each attaching means 41. Said openings 46 result from an inexpensive injection molding process for efficiently producing the attaching means 41. FIG. 1 to FIG. 3, as well as FIG. 13 show that the device having two faceplate bodies 10, a wall element 4 or a door element 4 can be effectively accommodated. It has proven to be particularly advantageous that the ratio V of material thickness M of the faceplate 20 and depth T of the support element 40 amounts approximately to 5%≦V≦35%, see FIG. 3. In the event the faceplate 20 is made from metal, according to the disclosure the following ratio V is suggested: 10%≦V≦25%, which is particularly advantageous. In the event the faceplate 20 is made from glass, the ratio V 15%≦V≦35 has proven to be particularly advantageous.

The length of the protecting element 30 is dimensioned such that different geometrics can be covered by the faceplate body 10 at functionally essential structural components 1. According to FIG. 10, the walling 43 of the second support element 40b has a length LR, which extends in the direction of the first support element 40a. Preferably, the length LS of the protecting element 39 amounts to 30% LR≦LS≦200 LR. According to FIG. 6, the protecting element 30 has a width extension B, which is oriented vertically to the longitudinal extension L, wherein the width extension B amounts to 40% BS≦B≦80, wherein BS is the longitudinal extension of the protecting side 52. Hereby, reliable variability can be achieved for the faceplate body 10 for accommodating different geometrics of functionally essential structural components 1.

1. A faceplate body for a functionally essential structural component, with
a faceplate having at least the appearance of a decorative element, and with a support element, wherein the faceplate body is configured with at least one attaching means for the attachment to the functionally essential structural component.

2. The faceplate body according to claim 1, wherein
the support element is made from a plastic material.

3. The faceplate body according to claim 1,
wherein the faceplate is positively and/or non-positively connected and/or connected by substance to the support element, wherein at least one connecting element, which is invisible from the outside, ensures that a reliable attachment between the faceplate and the support element is provided, and the connection between faceplate and connecting element is a latching connection.

4. The faceplate body according to claim 3,
wherein the faceplate and/or the support element include at least one connecting element (60), and the support element is configured like a frame and/or the course of the support element (40), at least on one side, is interrupted.

5. The faceplate body according to claim 1,
wherein the faceplate is made from a material, which is embodied in metal or glass or lumber or leather or plastic material.

6. The faceplate body according to claim 1,
wherein the faceplate includes a flat plate element, which has a front side and a back side, wherein the back side is facing and attached to the support element.

7. The faceplate body according to claim 1,
that wherein the faceplate and the support element are interconnected by means of an adhesive medium.

8. The faceplate body according to claim 1,
wherein the support element includes a walling and a bottom, wherein the back side of the faceplate rests on the bottom and/or is attached to the bottom, wherein the walling and the bottom form a common structural component as the support element.

9. The faceplate body according to claim 1,
wherein the bottom is configured with a depression, into which the adhesive medium can be introduced for achieving an attachment between the bottom and the faceplate, wherein the bottom includes an interior side and an exterior side, wherein the exterior side is configured with the depression.

10. The faceplate body according to claim 1,
wherein the plate element is configured and/or manufactured bending-free from metal, wherein the faceplate includes a stamped part made from metal.

11. The faceplate body according to claim 1,
wherein both the support element includes at least one connecting element and the faceplate includes at least one connecting element, wherein the connecting element of the support element is in operative connection with the connecting element of the faceplate.

12. The faceplate body according to claim 1,
wherein the connecting element is attached on the back side of the faceplate, wherein the connecting element of the faceplate includes a latching element, which is in operative connection with a counter-latching element, which the support element includes.

13. The faceplate body according to claim 1,
wherein the ratio V of material thickness M of the faceplate and depth T of the faceplate body amounts approximately to 5%≦V≦35.

14. The faceplate body according to claim 1,
wherein the bottom includes apertures and the apertures are like a segment of a circle.

15. The faceplate body according to claim 1,
wherein the ratio V of material thickness M of the faceplate, which is made from metal, and depth T of the support element may amount approximately to 10%≦V≦25%, or the ratio V of material thickness M of the faceplate, which is made from Glass, and depth T of the support element amounts approximately to 15%≦V≦35%.

16. The faceplate body according to claim 1,
wherein the course of the support element is adapted to the exterior contour of the faceplate, wherein the course of the support element is interrupted at least on one side.

17. A device having at least one faceplate body according to claim 1, wherein the faceplate body is disposed at a functionally essential structural component, wherein the functionally essential structural component is at least partially covered by the faceplate body (10).

18. The device according to claim 17,
wherein the functionally essential structural component includes a depression, into which the support element extends with the bottom thereof.

19. The device according to claim 17,
wherein the fitting includes two fitting elements, which are interconnected, wherein each fitting element includes a faceplate body on its exterior side.

20. The fitting according to claim 14,
at least one attaching element connects both fitting elements, wherein the attaching element is at least partially disposed in the aperture of the support element.

21. A faceplate arrangement having at least two faceplate bodies according to claim 1, wherein
a first faceplate body is disposed at a first functionally essential structural component and covers the first structural component least partially, a second faceplate body is disposed at a second functionally essential structural component and covers the second structural component at least partially, the first and the second faceplate bodies include several corner areas, wherein the corner areas of the first faceplate body, which are facing the second structural component, are configured as angular corner areas, and the corner areas of the first faceplate body, which are facing away from the second structural component, are configured as rounded corner areas.

22. The faceplate arrangement according to claim 1,
wherein the first faceplate body is disposed at a stationary part and the second faceplate body is disposed at a mobile part, wherein the stationary part and the mobile part are made from glass material.

23. A method for manufacturing a faceplate body according to claim 1, wherein
the faceplate body includes a faceplate as well as a support element, which is separately manufactured therefore, wherein the method comprises at least the step of:
b) attaching the support element to the faceplate.

24. The method according to claim 23,
wherein attaching the support element to the faceplate is realized via a latching connection and/or via bonding.

25. The method according to claim 23,
wherein the support element and/or the faceplate include at least one connecting element for achieving an attachment of the support element to the faceplate, wherein the connecting element is disposed at the support element and/or at the faceplate prior to attaching the support element to the faceplate.

26. The method according to claim 25,
wherein in a step a), which is prior to step b), at least one connecting element is disposed at the faceplate and the faceplate is disposed at a flat plate element by means of a welding process.

27. The method according to claim 23,
wherein in the step b) the faceplate is attached to the support element with the connecting element and the plate element and the connecting element are disposed at the plate element and form a faceplate.

28. The method according to claim 26,
wherein according to step a), the connecting element and/or the plate element are melted in a step c) and at least one melt is created at the plate element, wherein
d) the connecting element is lead into the melt of the plate element.

29. The method according to claim 28,
wherein in step c) there is a distance between the connecting element and the plate element.

30. The method according to claim 28,
that wherein according to step d), a lifting device moves the connecting element towards the plate element.

31. The method according to claim 23,
wherein the connecting element includes latching elements, wherein the connecting element includes a free end, which is configured tapered, wherein the free end is melted in a step a).

32. The method according to claim 28,
wherein above the free end, the connecting element includes a collar element, which acts as a support and/or positioning assistance during step d).

33. The method according to claim 25,
wherein the connecting element and the plate element are made from the same material.

34. The method according to claim 26,
wherein the ratio W between the thickness of the plate element to the diameter of the connecting element amounts to 0.5≦W≦1

35. The method according to claim 26,
wherein the plate element is manufactured bending-free.

36. The method according to claim 23,
wherein after the step b), the faceplate abuts at the support element without distance, wherein tension is effective between the faceplate and the support element.
